(19) United States
(12) Patent Application Publication
(10) Pub. No.: US 2008/0267752 A1
(43) Pub. Date: Oct. 30, 2008

(54) Waste handling apparatus and methods

(75) Inventor: Angel Delmo Ferioli, Madrid (ES)

Correspondence Address: WOOD, HERRON & EVANS, LLP, 2700 CAREW TOWER, 441 VINE STREET, CINCINNATI, OH, 45202, US

(73) Assignee: Environmental Technologies International LLC, Louisville, KY (US)

(21) Appl. No.: 12/167,696

(22) Filed: Jul. 3, 2008

Related U.S. Application Data
(62) Division of application No. 10/547,468, filed on Aug. 30, 2005.

(30) Foreign Application Priority Data
Mar. 11, 2003 (BR) PCT/BR2004/000025
Mar. 11, 2003 (BR) PI 0300535-6

(51) Int. Cl. B65F 3/00; B65F 1/00

(52) U.S. Cl. 414/349; 414/809

(57) ABSTRACT

This invention refers to a self-transported or towed equipment whose purpose is to collect, compact, and bag domestic, industrial and farming waste. The equipment is made up of a chassis (1) supporting a closed body (2) that is opened at both ends and has a back cover (4) to close the body and a moveable front compression plate (5). A clasping device of the accordion-like tube encircles the back part of the body (1). A bag sealing mechanism (3), operated by hydraulic cylinders (35, 36) and pliers (31) presses the loaded bag and squeezes it so as to place a sealing band manually. The lower part of the back cover (4) pivots on the chassis through a hydraulic cylinder (41) which is placed at the bottom of the chassis (1) and pulls cables (42) through grooved pulleys (43). The compression plate (5) is operated through a hydraulic system (6) made up of telescopic arms (61) propelled by independent hydraulics cylinders (62).

This invention refers to a equipment that is self-transported or self-towed, aimed at collecting, compacting, and bagging residues in general such as domestic, industrial, and farming waste.

The open-air collection and disposal of rubbish and waste in general is a growing problem that has serious ecological consequences.

Automotive vehicles are provided to collect domestic refuse; these vehicles have been specially designed and fabricated with features to receive, and compact the loads collected. However, given their capacity and high cost, these are only viable in large urban centers. This is why many cities hire private companies to collect the garbage, as they are specialized in this activity.

On the other hand, simpler ways of collecting and transporting garbage, such as, for instance, open trucks, dump-carts, or simple carts do not attend hygiene and safety requirements for both the population and the operators of this system.

In the case of trucks designed for the specific purpose of collecting garbage, the compaction rate is low, and so the volume of material collected is high. Because of this, the trucks need to be constantly unloaded, which means that they have to return to the garbage dumps that are located at remote places, thereby increasing the fuel consumption.

In the case of vehicles that are not specifically aimed at collecting garbage, the material collected is not compacted, which reduces the transport capacity of the vehicles all the more, and obliges to do constant trips to unload them.

The manner in which the garbage is disposed is also just as serious an issue, since in most cities, it is left in open-air dumps. Insects, rodents and all kinds of microorganisms, pathogenic or not, proliferate in these infamous dumps. As a result, these dumps are highly detrimental to the environment, as they contaminate the adjacent spring and ground water due to the infiltration and to the leaching of the liquids resulting from the decomposition and of the rainwater respectively.

Generally speaking, the problems described above also occur with the treatment of industrial and farming waste.

This invention is therefore to have an equipment capable of solving the limitations of the abovementioned state of technology efficiently. The solution is a self-transported or self-towed piece of equipment, designed to collect, compact, and bag domestic, industrial, and farming waste. The equipment has a chassis, supporting a body that is closed with a back closing cover; it also has a movable front plate that compresses the waste, and is displaced through a hydraulic system. The back cover moves at a certain angle of the chassis and transforms into a chute to unload the material collected and compacted. A peripheral feeding device from a waterproof and flexible tube minimizes the harmful effects on nature. The tube has a closing device that enables the operator to apply a sealing band at the end of the bag while applying a second sealing band before sectioning the tube to form the bottom of a new bag.

The collecting, compacting and bagging equipment that is the subject of this invention presents the following advantages on the state of technology:
it has a waste compacting system with a compression plate that is operated through a hydraulic cylinder and driven through a telescopic arm, which ensures a high compression rate and drastically reduces the volume of waste;
it increases significantly the transport capacity of the vehicle, since the material collected presents a high compacting rate;
it has a hydraulic mechanism that to tilt the compression plate that ensures a homogenous compaction of the waste over the entire volume of the equipment body;
it has a two-part compression plate with an upper tilting portion that enables to introduce waste through the front and leaving the entire volume of the body free for loads;
it has a feeding device for a continuous and waterproof tube to bag the compacted waste, which is attached to the back cover;
it has a automatic bag sealing device, which only requires that the operator passes and closes the sealing band when the tube is full and when the tube is ready to be filled up;
it has a tilting back cover that serves as a discharge chute of the sealed bag filled with compacted waste;
it has a collecting system for the liquids and drippings extracted from the waste during collection and compressing, thereby ensuring a safe and hygienic operation.

The waste collecting, compacting and bagging equipment in reference in this invention is easier to understand in the following specifications, which are given through the drawings in appendix and listed below; these illustrate the best concretization form, which must not be looked upon as limiting for the invention, where:

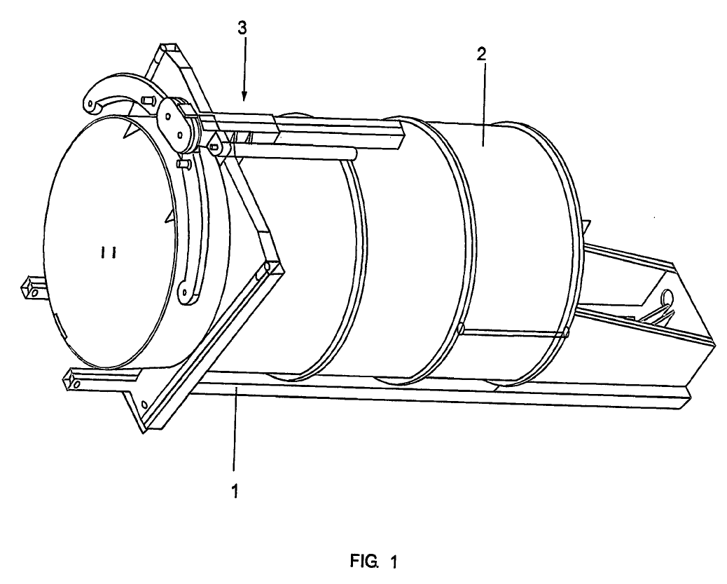

FIG. 1—equipment perspective;

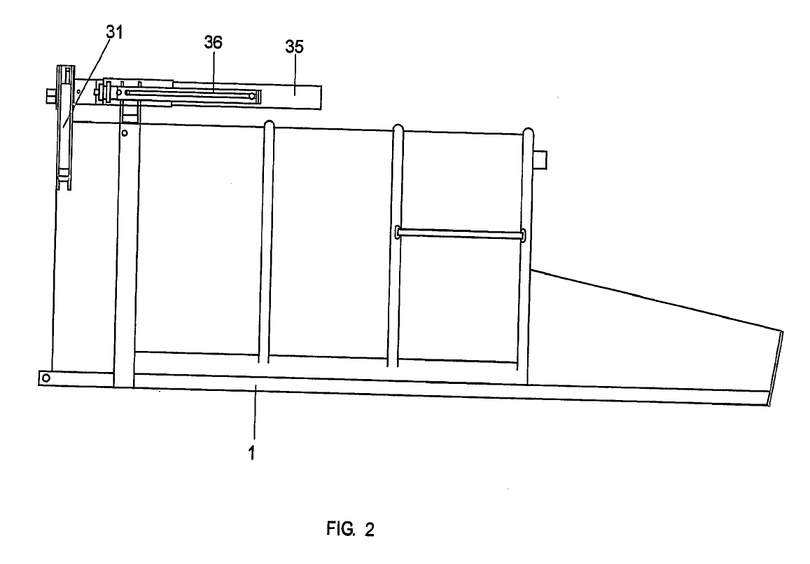

FIG. 2—side view of the equipment;

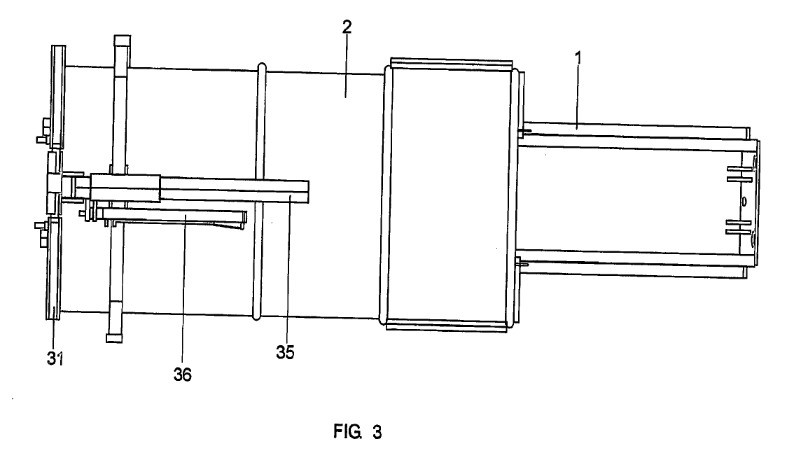

FIG. 3—upper view of the equipment;

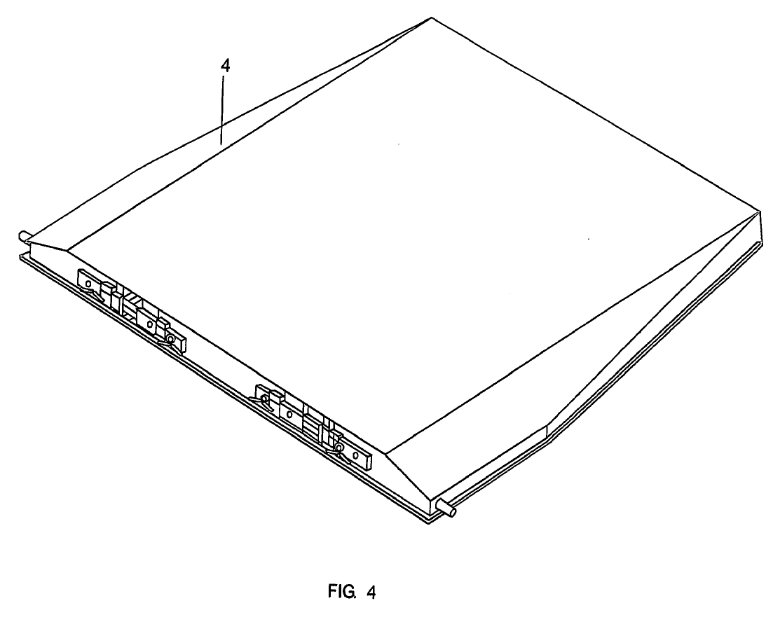

FIG. 4—view from the back cover of the equipment;

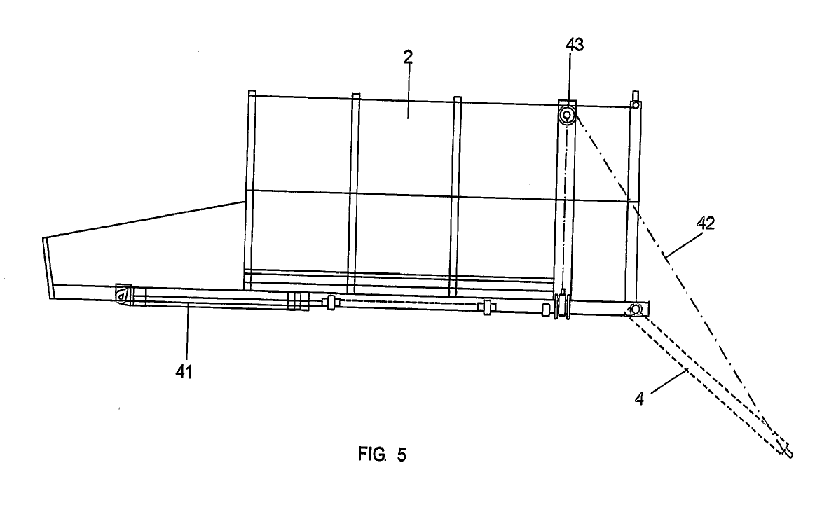

FIG. 5—side view of the equipment detailing the operating mechanism of the back cover;

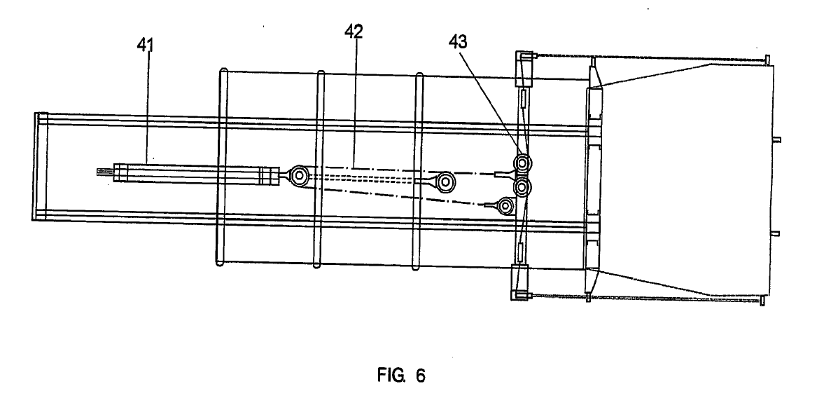

FIG. 6—lower view of the equipment detailing the operating mechanism of the back cover;

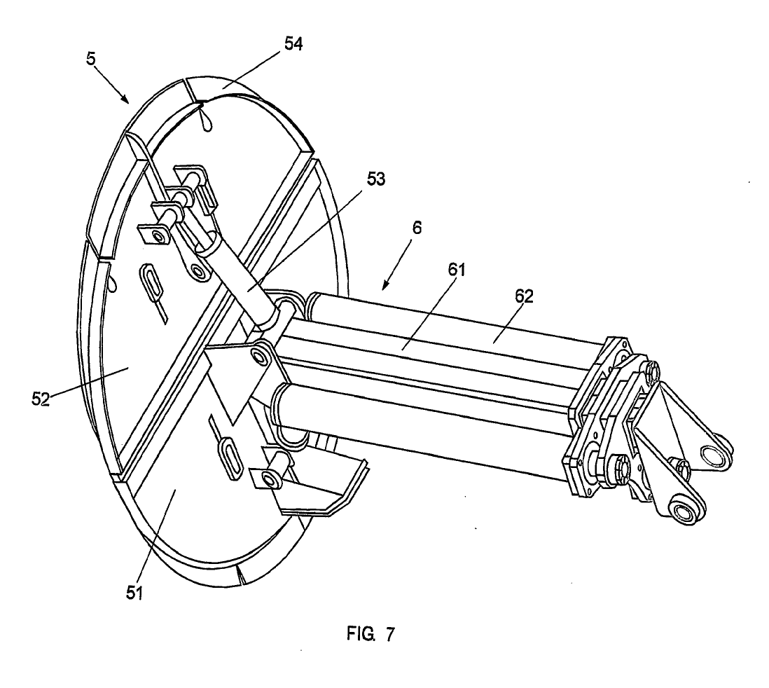

FIG. 7—perspective of the compression plate;

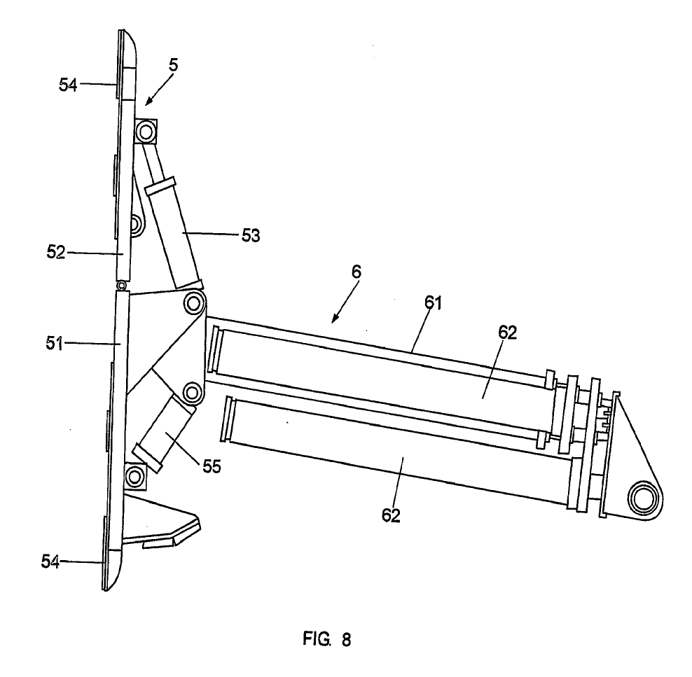

FIG. 8—side view of the compression plate;

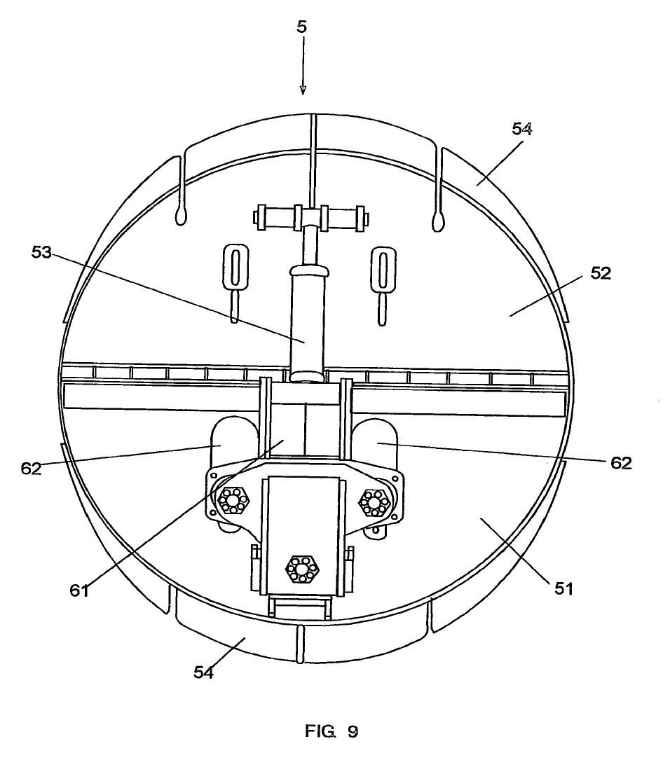

FIG. 9—front view of the compression plate;

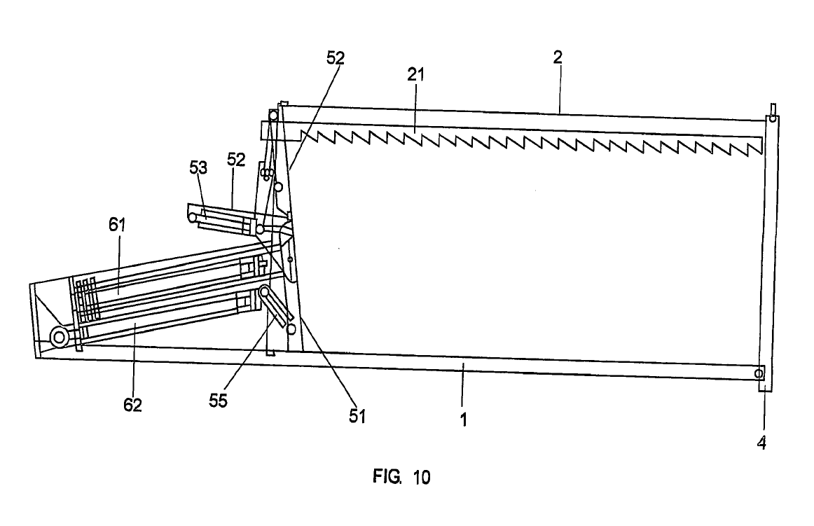

FIG. 10—side section of the equipment with the compression plate set backwards;

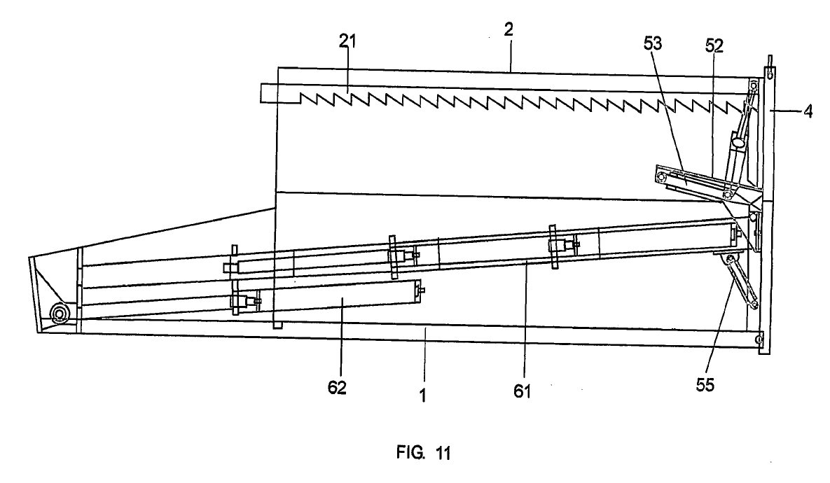

FIG. 11—side section of the equipment with the compression plate set forwards;

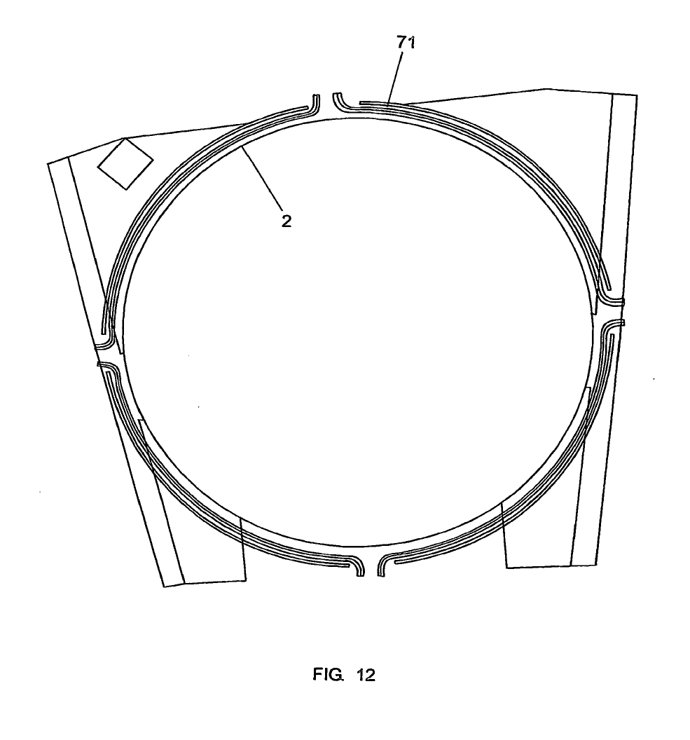

FIG. 12—front view of the set of clips of the bagging tube;

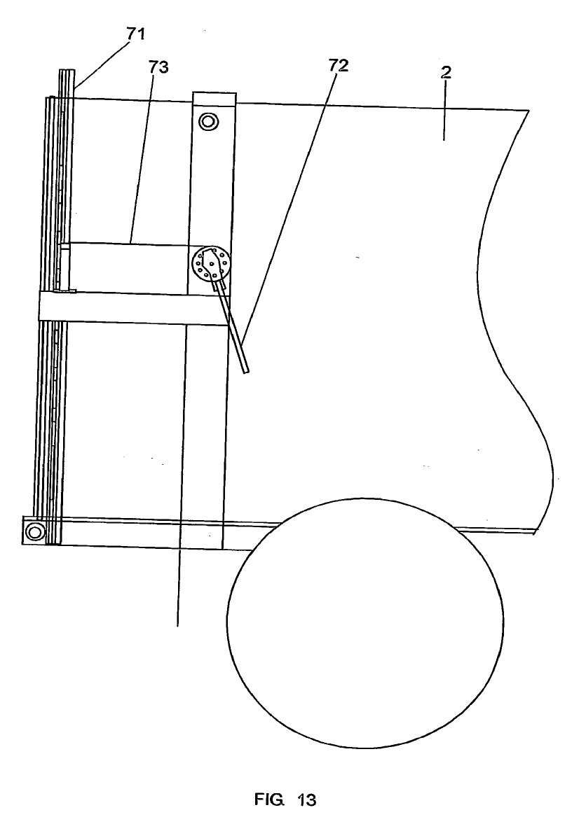

FIG. 13—side view of the set of clips of the bagging tube;

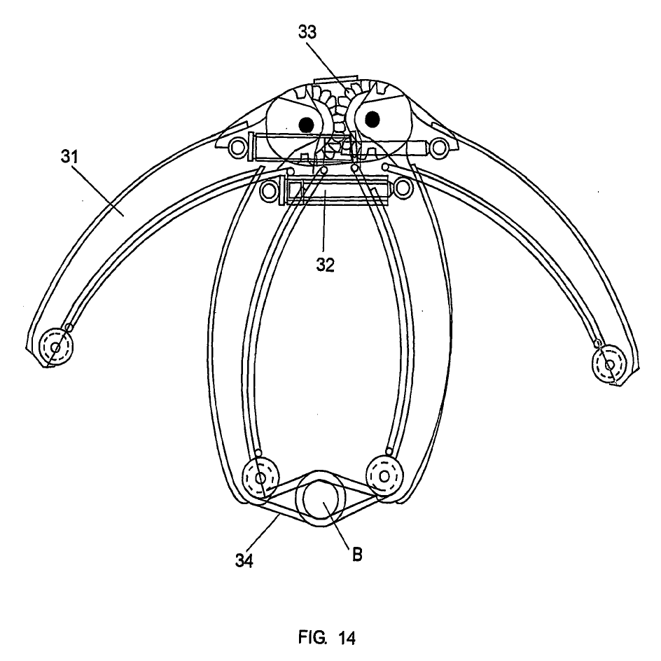

FIG. 14—front view of the set of closing pliers of the tube;

FIGS. 1 to 3 shows the equipment invented with the chassis (1), supporting a closed body (2), preferably a cylindrical that is opened at both ends and has a back cover to close the body and a moveable front compression plate (not shown in these figures). A clasping device of the accordion-like tube encircles the back part of the body (i). A bag sealing mechanism (3), operated by hydraulic cylinders (35 and 36) and pliers (31) presses the loaded bag and squeezes it so as to place a sealing band manually.

FIGS. 4 to 6 show the back cover (4) whose lower part pivots on the chassis (1) and transforms into a discharge chute for the collected, compacted, and bagged material. The opening and closing of the cover (4) is operated by a hydraulic cylinder (41) which is placed at the bottom of the chassis (1) and pulls cables (42) which lower or the aforesaid cover (4) thanks to grooved pulleys (43).

FIGS. 7 to 9 detail the compression plate (5) that is operated through a hydraulic system (6), preferably made up of four telescopic arms (61) which are propelled by three independent hydraulic cylinders (62). So, you obtain the rigidity characteristic of telescopic arms that are operated by dint of independent hydraulic cylinders of identical diameter, which surpasses the advantages presented by the traditional telescopic hydraulic cylinders of decreasing diameters.

The compression plate (5) is made up of a lower semicircle (51) on which an upper semicircle (52) swings. The upper semi-plate (52) is moved by a hydraulic cylinder (53) and is maintained down constantly so as to form a front opening to load the body (2).

Due to the inclination of the compression plate (5) on its way inside the body (2) the compression plate has a pair of sliding tongues (54) which turn the plate (5) whenever they are set backwards and turn the plate (5) into an elliptical shape whenever they are put forwards.

FIGS. 10 and 11 show the compacting cycle of the waste load when the plate (5) is moved backward towards the back cover (4) through the telescopic arms (61) propelled by the hydraulic cylinders (62). On initiating the compaction stage, this plate (5) is inclined so as to help raise the waste and stop a higher degree of compaction at the base of the body (2). At the end of the cycle, a hydraulic cylinder (55) corrects the position of the plate (5) by turning it orthogonally to the axis of the body and parallel to the cover (4). To stop the compacted waste to return to the plate (5), sprocket plates (21) are placed in the upper part, inside the body (2).

FIGS. 12 and 13 detail the tube set of clips (7) at the back of the body (2). This tube can be folded so as to enable a long-sized load in a reduced place. The device has four arcs shaped clips (71) that press the tube blade against the external surface at the back of the body (2). A lock (72) loosens the cables (73) that maintain the clip (71) pressed against the body (2). The lock (72) is operated whenever a quick liberation of portion of the tube is required during the unloading of the compacted waste.

FIG. 14 shows the bag sealing mechanism (3) separately; the mechanism is made up of two arc shaped pliers (31) that are operated by a hydraulic cylinder (32) and synchronized by toothed segments (33). The pliers (31) serve to guide and lead the two flexible and retractile coiled ropes (34) like forks that encircle the end portion of the bag (B) and make it touch the back of the body (2). Those ropes (34) are drawn back thanks to a grooved-pulley system pulled through a hydraulic cylinder (35), which closes the bag by squeezing it. The pliers (31) moving transversally in a scissor type of way serve to always guide the rope (34) loop towards the central portion of the bag mouth.

Before starting to compress the tube with the rope (34), the entire structure of the pliers (31) is propelled outside the body (2) through the hydraulic cylinder (36), thereby leaving the pliers (31) free to squeeze the already filled tube. This is when part of the tube also slides and follows the movement.

Besides closing the bag, the pliers (31) move longitudinally through a hydraulic arm (36) that pushes the bag towards the back cover (4) that is already lowered, thereby allowing for the opening of enough space to place the sealing band that closes the bag.

Using the pull of gravity, a dripping tank (not shown) placed at the lower back part of the body (2) has a lower drainpipe (not shown) that collects the liquids obtained through compaction.

The operating sequence of the equipment is made up of the following steps:
it starts by collecting the waste that is thrown manually inside the body (2) thanks the opening at the front when the upper semi-plate (52) of the compression plate (5) is turned downwards;
the compression plate (5) compacts the load at regular intervals after the upper semi-plate (52) is lifted and the hydraulic cylinders (62) and the respective arms (81) towards the closing cover of the body (4) are operated.
after various successive cycles of compressing and loading the waste collected, the load must first be unloaded by opening the back cover (4) that forms a chute for the bagged waste;
by that time, the tube opening is already closed by the sealing band and the bottom is in contact with the internal surface of the cover (4) before the opening when the cylinders (62) start throwing the compacted waste out, which pulls the adequate length of tube;
once this ejection is over, the bag sealing device (3) is operated; it first ejects the pliers structure (31) outside the body (2) through the hydraulic cylinder (36) and after the rope (34) is pulled by the hydraulic cylinder (35) thereby squeezing the tube that is full;
the bagged load is propelled outside on the chute formed by the back cover (4); the operator applies the sealing band to close the tube and a second one at same distance so as to close the opening of a new portion of tube, before finally cutting it, thereby separating the bag;
a new step is then initiated to load the waste; the set of pliers (31) is drawn back and the back cover (4) is lifted; the plate (5) is drawn back and the upper semi-plate (52) is lowered to open the front opening and load the waste.

Off course, the equipment suggested in this invention might be used for other means like, for instance, to bag raw material of diverse types. It also may be used efficiently to form silos and to put vegetal material into silos.

1-11. (canceled)

12. Waste handling apparatus comprising:
a cylindrical compaction chamber developed about an axis and having a discharge door proximate one discharge end thereof and a driver compression plate spaced apart from said discharge door;
said compression plate comprised of two semi-circular members hinged together along respective straight edge of each member, and having ellipse forming portions thereon;
said compression plate disposed at an angle to said axis with said cylindrical chamber.

13. Apparatus as in claim 12 wherein said discharge door is selectively moveable with respect to said chamber and in one position provides a discharge chute for compacted waste.

14. Apparatus as in claim 12 further including hydraulic means for pivoting one of said members with respect to the other.

15. Apparatus as in claim 14 further including hydraulic means for driving said compression plate toward said discharge end.

16. Apparatus as in claim 12 wherein a lower semi-elliptical member of said compression plate is closer to said discharge end than an upper semi-elliptical member.

17. Apparatus as in claim 12 further including anti-reversing rack means for selectively preventing movement of said compression plate away from said discharge end.

18. Apparatus as in claim 12 further including a collapsed waste receiving bag having a mouth disposed about said discharge end for receiving compacted waste when said discharge door is opened.

19. A method of handling waste in a compression apparatus including a cylindrical compression chamber having a discharge end, a moveable discharge door; and a moveable compression plate in said chamber, said compression plate comprising upper and lower plate members, said method comprising the steps of:
turning said upper plate member from a first position to a second position with respect to said lower plate member to define a waste receiving opening between said upper member and an inner wall surface of said chamber;
depositing waste in said chamber and returning said upper plate member to said first position; and
driving said compression plate toward said discharge end to compact waste against said discharge door.

20. A method as in claim 19 including driving said compression plate along an axis of said chamber, but at an angle thereto, in a compression direction.

21. A method as in claim 20 including driving a lower plate member in said chamber in an advanced position with respect to said upper plate member.

22. A method as in claim 21 including:
ceasing said driving;
lowering said upper plate member;
introducing additional waste into said chamber;
raising said upper plate member;
then continuing said driving of said compression plate in a compression direction to compact waste toward said discharge door.

23. A method as in claim 22 including the further steps of:
opening said discharge door;
discharging compacted waste into a bag having a mouth disposed about said discharge end; and
closing said bag about compacted waste.

24. A method as in claim 23 including incrementally discharging waste into said bag.
